(19) United States
(12) Patent Application Publication
(10) Pub. No.: US 2017/0372144 A1
(43) Pub. Date: Dec. 28, 2017

(54) TERMINAL SURVEILLANCE DEVICE, AUTOMATIC TELLER MACHINE, DECISION METHOD, AND PROGRAM ON A STORAGE MEDIUM

(71) Applicant: Oki Electric Industry Co., Ltd., Tokyo (JP)

(72) Inventors: Naoki KURITA, Tokyo (JP); Makoto MASUDA, Tokyo (JP); Hideto KOIKE, Tokyo (JP)

(73) Assignee: Oki Electric Industry Co., Ltd., Tokyo (JP)

(21) Appl. No.: 15/545,236

(22) PCT Filed: Oct. 6, 2015
(86) PCT No.: PCT/JP2015/078361

§ 371 Date: Jul. 20, 2017

(30) Foreign Application Priority Data
Feb. 26, 2015 (JP) 2015-036607

(51) Int. Cl. G06K 9/00; G07F 19/00; H04N 7/18

(52) U.S. Cl. CPC G06K 9/00771; H04N 7/18; G06K 9/00335; G07F 19/207

(57) ABSTRACT

A terminal surveillance device, an automatic teller machine, a decision method, and a program on a storage medium that can detect suspicious motion at a terminal device. The terminal surveillance device includes a motion information acquisition unit configured to acquire motion information indicating a motion of a user at a terminal device, a specification unit configured to specify a specific motion of the user from the motion information acquired by the motion information acquisition unit, and a state information acquisition unit configured to acquire state information indicating a state of the terminal device. A decision unit decides whether the specific motion specified by the specification unit is normal, on the basis of a relationship between the specific motion and the state information acquired by the state information acquisition unit.

### TECHNICAL FIELD

The present invention relates to a terminal surveillance device, an automatic teller machine, a decision method, and a program.

### BACKGROUND ART

Technologies have been requested for the secure use of confidential information of individual persons with the recent growth of information societies. Examples of confidential information include card information stored in magnetic media such as credit cards and cash cards, and personal identification numbers for personal authentication. As crimes related to confidential information, the crimes occur, for example, of attaching a device (which will also be referred to as skimmer) capable of reading card information to the card insertion slot of a terminal device, illegally acquiring the card information of a user while the user is using the terminal device, and hereby creating a counterfeit card. Examples of terminal devices that can be involved in such crimes include automatic teller machines (ATMs).

As technologies for preventing such crimes, a variety of technologies are developed such as a technology of detecting a suspicious behavior including attaching a skimmer and a technique of detecting a suspicious object including an attached skimmer.

For example, Patent Literature 1 below discloses the technology of shooting images from the end of a transaction to the start of the next transaction at predetermined intervals on the basis of the transaction information of an ATM with a surveillance camera that shoots images of the card insertion slot, on which a skimmer would be installed, the front panel of the ATM, on which images of card operations and the key entry of personal identification numbers are secretly shot in many cases, and the area around the front panel, and obtaining the differences therebetween, thereby automatically detecting a suspicious object.

Patent Literature 2 below discloses the technology of irradiating the front panel of an ATM with infrared patterns, and comparing the patterns, thereby detecting a change in the shape of the front panel of the ATM caused by attaching a skimmer.

Patent Literature 3 below discloses the technology of associating an access detection sensor, a camera that keeps a financial institution booth under surveillance, and a camera that keeps an ATM under surveillance, with each other, thereby keeping the behaviors of a user under tracking surveillance to detect a suspicious behavior and notify an management terminal of the suspicious behavior of the user and the captured image.

Patent Literature 4 below discloses the technology of extracting verbs indicating the type of motion of a suspicious person and nouns related to a suspicious motion, and detecting the combination of frequent verbs and nouns, thereby registering a frequent behavior as a suspicious behavior to improve the detection rate of future suspicious behaviors.

### CITATION LIST

### Patent Literature

Patent Literature 1: JP 2007-280317A

Patent Literature 2: JP 2008-27259A

Patent Literature 3: JP 2008-15686A

Patent Literature 4: JP 2010-146298A

### SUMMARY OF INVENTION

### Technical Problem

Skimmers have been, however, smaller in recent years. It is possible to attach a skimmer into a card insertion slot. It is therefore difficult for the technologies disclosed in Patent Literatures 1 and 2 above to detect the attached skimmer on the basis of the appearance or shape of the front panel of the ATM. Further, the motion of attaching a skimmer into a card insertion slot looks similar to the motion of normally putting a card into a card insertion slot. It is therefore difficult for the technologies disclosed in Patent Literatures 3 and 4 above to detect the motion of attaching a skimmer as a suspicious behavior in some cases.

The present invention is then devised in light of the above-described problems. An objective of the present invention is to provide a novel and improved terminal surveillance device, automatic teller machine, decision method, and program that can more accurately detect a suspicious motion at a terminal device.

### Solution to Problem

To solve the above-described problem, according to an aspect of the present invention, there is provided a terminal surveillance device including: a motion information acquisition unit configured to acquire motion information indicating a motion of a user at a terminal device; a specification unit configured to specify a specific motion of the user from the motion information acquired by the motion information acquisition unit; a state information acquisition unit configured to acquire state information indicating a state of the terminal device; and a decision unit configured to decide whether the specific motion specified by the specification unit is a normal motion, on the basis of a relationship between the specific motion and the state information acquired by the state information acquisition unit.

The decision unit may decide whether the specific motion is a normal motion, on the basis of whether the specific motion is a motion corresponding to the state of the terminal device.

The decision unit may decide whether the specific motion is a normal motion, on the basis of whether the terminal device transitions to a state corresponding to the specific motion after the specific motion is specified.

The terminal surveillance device may further include: a report unit configured to report a decision result from the decision unit.

The state information acquisition unit may acquire the state information on the basis of a signal output from the terminal device.

The state information acquisition unit may acquire the state information on the basis of sensor information output from a sensor device that targets the terminal device for sensing.

The state information acquisition unit may acquire the state information on the basis of the sensor information obtained by sensing information reported from a report device provided to the terminal device.

The report device may be provided at a higher position than a position of a card insertion slot of the terminal device.

The motion information acquisition unit may acquire the motion information from a camera that acquires a moving image or a still image.

The terminal device may be an automatic teller machine.

The decision unit may decide whether the specific motion is a normal motion, on the basis of whether the specific motion is specified after a transition of the state of the terminal device, and a state to which the terminal device transitions is a state corresponding to the specified specific motion.

Further, to solve the above-described problem, according to another aspect of the present invention, there is provided a terminal surveillance device including: a memory and/or a storage device configured to store data; and a control unit. The memory and/or the storage device stores each of 1) a motion information acquisition module, 2) a specification module, 3) a state information acquisition module, and 4) a decision module. The control unit executes each of the modules in 1) to 4), and a detail of execution of the control unit includes following A) to D): A) executing the motion information acquisition module to acquire motion information indicating a motion of a user at a terminal device; B) executing the specification module to specify a specific motion of the user on the basis of the motion information acquired in A); C) executing the state information acquisition module to acquire state information indicating a state of the terminal device; and D) executing the decision module to decide whether the specific motion specified in B) is a normal motion, on the basis of a relationship between the specific motion and the state information acquired in C).

Further, to solve the above-described problem, according to another aspect of the present invention, there is provided an automatic teller machine including: a motion information acquisition unit configured to acquire motion information indicating a motion of a user; a specification unit configured to specify a specific motion of the user from the motion information acquired by the motion information acquisition unit; a state information acquisition unit configured to acquire state information indicating a state of the automatic teller machine; and a decision unit configured to decide whether the specific motion specified by the specification unit is a normal motion, on the basis of a relationship between the specific motion and the state information acquired by the state information acquisition unit.

The state information acquisition unit may acquire the state information on the basis of sensor information output from a sensor included in the automatic teller machine.

The automatic teller machine may further include: a report unit configured to report a decision result from the decision unit; a sensor configured to output sensor information as a sensing result; and a camera configured to output an image. The state information acquisition unit may acquire the state information on the basis of at least two of the sensor information, the image, and the decision result.

The automatic teller machine may further include: a sensor configured to output sensor information as a sensing result; a lamp; and a camera configured to output an image. The state information acquisition unit may acquire the state information on the basis of at least one of an image obtained by the camera capturing display of the lamp, and the sensor information.

Further, to solve the above-described problem, according to another aspect of the present invention, there is provided an automatic teller machine including: a memory and/or a storage device configured to store data; and a control unit. The memory and/or the storage device stores each of 1) a motion information acquisition module, 2) a specification module, 3) a state information acquisition module, and 4) a decision module. The control unit executes each of the modules in 1) to 4), and a detail of execution by the control unit includes following A) to D): A) executing the motion information acquisition module to acquire motion information indicating a motion of a user; B) executing the specification module to specify a specific motion of the user on the basis of the motion information acquired in A); C) executing the state information acquisition module to acquire state information indicating a state of the automatic teller machine; and D) executing the decision module to decide whether the specific motion specified in B) is a normal motion, on the basis of a relationship between the specific motion and the state information acquired in C).

Further, to solve the above-described problem, according to another aspect of the present invention, there is provided a decision method including: a first step of acquiring motion information indicating a motion of a user; a second step of specifying a specific motion of the user on the basis of the motion information; a third step of acquiring state information indicating a state of a terminal device; and a fourth step of deciding whether the specific motion is a normal motion, on the basis of a relationship between the specific motion and the state information. A control unit executes the first to fourth steps, and it is decided as a result whether the motion of the user is normal.

Further, to solve the above-described problem, according to another aspect of the present invention, there is provided a program recorded on a recording medium, the program causing a computer to function as: a motion information acquisition unit configured to acquire motion information indicating a motion of a user; a specification unit configured to specify a specific motion of the user on the basis of the motion information acquired by the motion information acquisition unit; a state information acquisition unit configured to acquire state information indicating a state of a terminal device; and a decision unit configured to decide whether the specific motion is a normal motion, on the basis of a relationship between the specific motion and the state information.

### Advantageous Effects of Invention

As described above, according to the present invention, it is possible to more accurately detect a suspicious motion at a terminal device.

### BRIEF DESCRIPTION OF DRAWINGS

FIG. 1 is a diagram illustrating an example of a terminal surveillance system according to the present embodiment.

FIG. 2 is a diagram illustrating an example of an image shooting rage of a camera according to the present embodiment.

FIG. 3 is a block diagram illustrating an example of a logical configuration of a terminal surveillance device according to the present embodiment.

FIG. 4 is a flowchart illustrating an example of state transitions of an ATM, from which money is withdrawn.

FIG. 5 is a flowchart illustrating an example of a flow of terminal surveillance processing executed by the terminal surveillance device according to the present embodiment.

FIG. 6 is a block diagram illustrating an example of the logical configuration of the terminal surveillance device according to the present embodiment.

FIG. 7 is a diagram for describing an example of a report device provided to an ATM according to the present embodiment.

FIG. 8 is a block diagram illustrating an example of a hardware configuration of an information processing device according to the present embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Overview

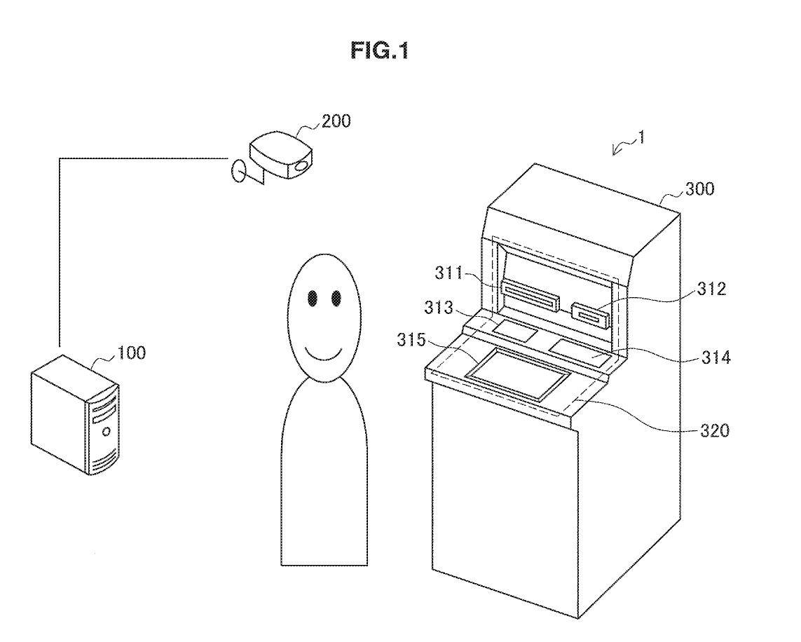

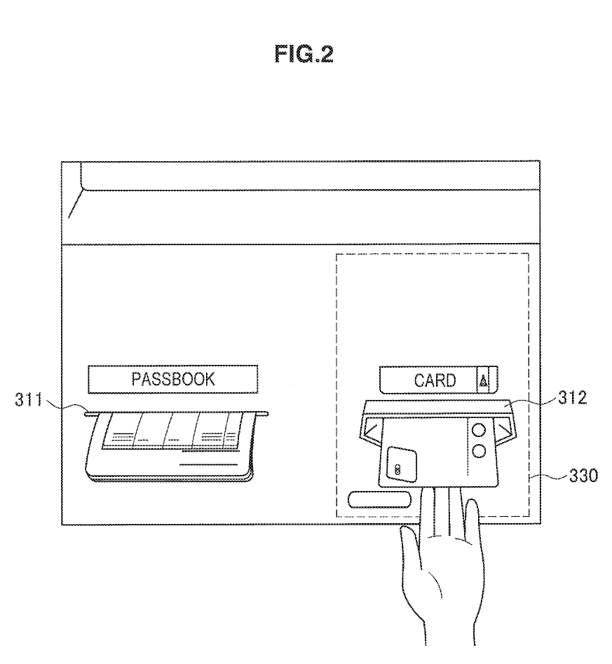

First, the overview of a terminal surveillance system according to an embodiment of the present invention will be described with reference to FIGS. 1 and 2.

FIG. 1 is an explanatory diagram illustrating an example of a terminal surveillance system 1 according to the present embodiment. As illustrated in FIG. 1, the terminal surveillance system 1 includes a terminal surveillance device 100, a sensor device 200, and a terminal device 300 that is targeted for surveillance.

The terminal device 300 is a customer-operated terminal device that executes financial transactions on the basis of operations of users. The terminal device 300 can be implemented, for example, by an ATM, an automatic passbook issuing machine, or a processing terminal device for credit cards. In the example illustrated in FIG. 1, the terminal device 300 is an ATM. The ATM 300 can be installed in a variety of institutions such as branch offices of financial institutions, convenience stores, stations, hotels, hospitals, amusement parks, restaurants, and office buildings.

A passbook insertion slot 311 accepts and ejects a passbook of a user. A card insertion slot 312 accepts and ejects a card of a user. A coin dispensing slot 313 functions as a deposit slot through which a user deposits coins, and a withdrawal slot through which a user withdraws coins. A bill dispensing slot 314 functions as a deposit slot through which a user deposits bills, and a withdrawal slot through which a user withdraws bills. An operation display unit 315 has the functions of a display unit that displays a guidance screen for an operation of a user, and an operation unit that detects an operation of a user. The function of the display unit is implemented, for example, by a cathode ray tube (CRT) display device, a liquid crystal display (LCD) device, and an organic light emitting diode (OLED) device. Further, the function of the operation unit is implemented, for example, by a touch panel. Although FIG. 1 illustrates an example in which the functions of the display unit and the operation unit are integrated with each other, the functions of the display unit and the operation unit may also be separated from each other.

Although not illustrated in FIG. 1, the ATM 300 may include a statement ejection slot that ejects a statement showing the details of a transaction. For example, the statement ejection slot may be provided under the card insertion slot 312, or provided to the ATM 300 that does not accept passbooks instead of the passbook insertion slot 311.

The sensor device 200 is a device that targets the ATM 300 for sensing. The sensor device 200 can be implemented, for example, by a camera that shoots moving images/still images, an infrared sensor, a distance sensor, or a radio wave sensor. For example, when a user makes the motion of holding a shield between the card insertion slot 312 and the sensor device 200, the sensor device 200 implemented as a camera can be used to recognize and detect an image of the shield as an abnormal motion. When the sensor device 200 is implemented as a distance sensor, the sensor device 200 can accurately sense whether a user is, for example, raising his or her hand at the height of the card insertion slot 312. In the example illustrated in FIG. 1, the sensor device 200 is a camera that shoots moving images. Additionally, the terminal surveillance system 1 may include multiple cameras 200, or target multiple ATMs 300 for surveillance. Further, the terminal surveillance system 1 may use the multiple cameras 200 to keep the single ATM 300 under surveillance, or use the single camera 200 to keep the multiple ATMs 300 under surveillance.

The camera 200 shoots an image of a user operating the ATM 300, and outputs the shot moving image to the terminal surveillance device 100. The image shooting range may be set to include the whole of the ATM 300, or include the area (which will also be referred to as operated area) of the ATM 300 which a user operates. Similarly, the image shooting range may be set to include the whole of a user, or include a part of a user. In any case, the image shooting range only has to make it possible to shoot an image of a specific motion. The specific motion refers to motions of a user such as operating a transaction start button, inserting a card, inserting a passbook, entering a personal identification number, entering a transaction volume, receiving a bill, receiving a card, receiving a passbook, and receiving a statement which are supposed to be performed in a transaction. Here, an example of the image shooting range of the camera 200 will be described with reference to FIG. 2.

FIG. 2 is a diagram illustrating an example of the image shooting rage of the camera 200 according to the present embodiment. In the example illustrated in FIG. 2, the image shooting range 330 of the camera 200 is set to allow the camera 200 to shoot an image of a hand of a user performing a specific motion such as inserting or receiving a card. Additionally, in the example illustrated in FIG. 1, the image shooting range 320 is set as the area including the passbook insertion slot 311, the card insertion slot 312, the coin dispensing slot 313, the bill dispensing slot 314, and the operation display unit 315.

In the example illustrated in FIG. 1, the camera 200 is installed at a higher position than the position of the ATM 300, and shoots images that look down on users and the ATM 300, but the present invention is not limited to the example. For example, the camera 200 may be installed to shoot images of users and the ATM 300 from the horizontal direction. In that case, it is difficult for the camera 200 to shoot clear images of the key entry of a user, the surface of a card, and the details of a statement. Accordingly, it is possible to improve the security of the user. Further, the camera 200 may be integrated with the ATM 300. In that case, the calibration of the camera 200 is easier, and the learning of the terminal surveillance device 100 described below is further easier.

The terminal surveillance device 100 is a device that detects abnormal motions such as attaching a skimmer to the ATM 300 that is targeted for surveillance. For example, the terminal surveillance device 100 detects an abnormal motion on the basis of the relationship between a motion of a user an image of which is shot by the camera 200 and the state of the ATM 300.

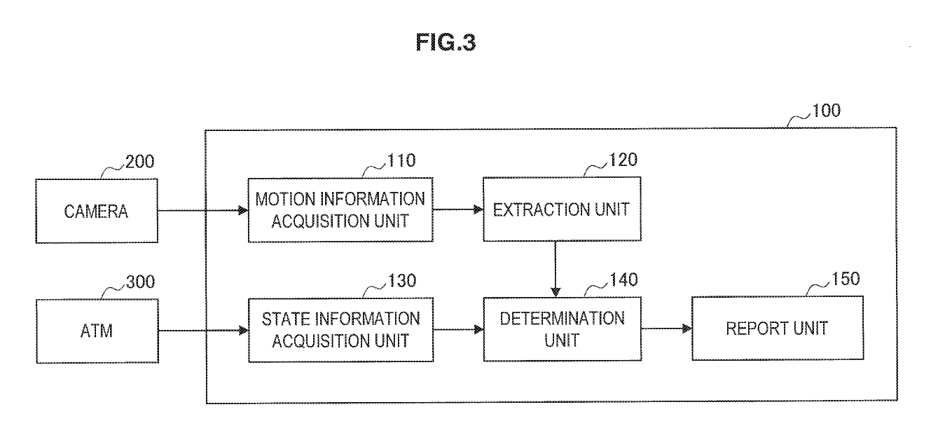

The overview of the terminal surveillance system 1 according to the present embodiment has been described above. Next, a first embodiment will be described in detail with reference to FIGS. 3 to 5.

### 2. First Embodiment

The terminal surveillance device 100 acquires information indicating the state of the ATM 300 on the basis of a signal output from the ATM 300 in the present embodiment.

### 2.1. Configuration Example

FIG. 3 is a block diagram illustrating an example of the logical configuration of the terminal surveillance device 100 according to the present embodiment. As illustrated in FIG. 3, the terminal surveillance device 100 includes a motion information acquisition unit 110, an extraction unit 120, a state information acquisition unit 130, a determination unit 140, and a report unit 150.

### (1) Motion Information Acquisition Unit 110

The motion information acquisition unit 110 has a function of acquiring motion information indicating a motion of a user at the ATM 300. The motion information acquisition unit 110 is connected to the camera 200 in a wired or wireless manner directly or indirectly via another device. For example, the motion information acquisition unit 110 acquires, as motion information, a moving image (chronological image sequence) that is shot by the camera 200 and shows a motion of a user.

### (2) Extraction Unit 120

The extraction unit 120 has a function of extracting a specific motion of a user from motion information acquired by the motion information acquisition unit 110. For example, the extraction unit 120 performs image recognition processing on a shot moving image showing a motion of a user, thereby extracting a specific motion. There are various possible technologies for extracting a specific motion from a moving image. For example, the technique described in “NANRI Takuya & OTSU Nobuyuki, “Anomaly Detection in Motion Images Containing Multiple Persons,” Journal of Information Processing Society of Japan Computer Vision and Image Media, 46 (SIG_15 (CVIM_12)), 43 to 50, 2005-10-15.” may be applied.

The technique described in the above literature will be described in detail. The technique regards frequent motions as usual motions, and defines the motions other than the usual motions as abnormal motions. The technique extracts image feature values called cubic high-order local autocorrelation (CHLAC) features from an input image sequence showing a large number of usual motions for learning usual motions, and learns subspaces on the basis of the image feature values of the normal motions. Usual motions or abnormal motions are identified by the CLAFIC method (subspace method). The abnormal motions can be defined as deviations from the subspaces of the normal motions. Accordingly, projecting an image feature value extracted from an image sequence of abnormal motions onto a subspace of usual motions results in a greater projection length. The technique can therefore detect an abnormal motion by performing threshold processing on the projection length. Further, even projecting a CHLAC feature extracted from an input image showing usual motions onto a subspace does not considerably change the distance from the subspace because of the linearity of CHLAC and the subspace.

The extraction unit 120 learns one or more specific motions in advance, and determines whether a specific motion is made, on the basis of motion information acquired from the motion information acquisition unit 110. The extraction unit 120 then outputs information indicating the specific motion determined to be made to the state information acquisition unit 130.

### (3) State Information Acquisition Unit 130

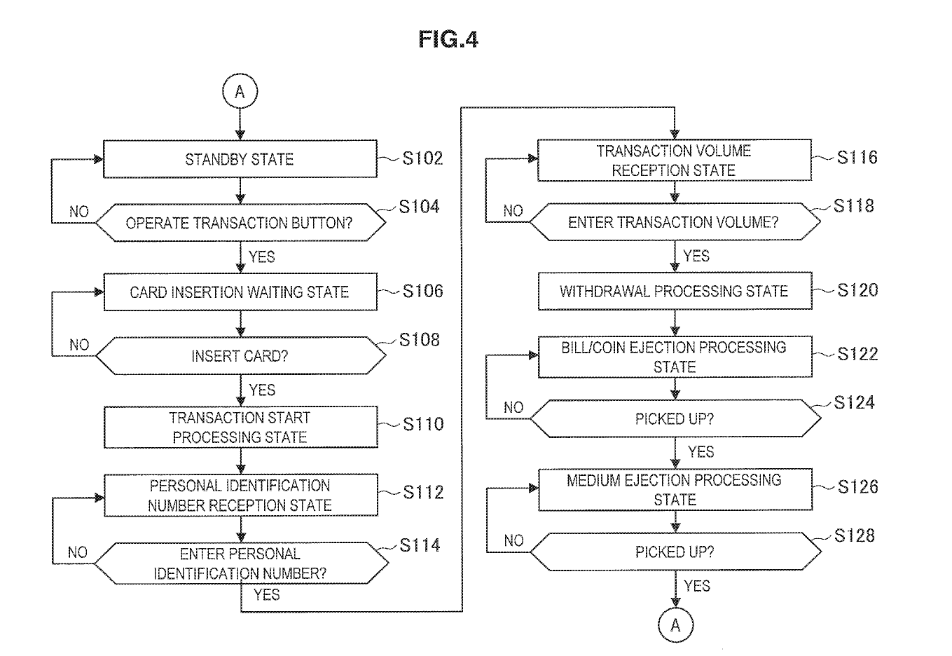

The state information acquisition unit 130 has a function of acquiring state information indicating the state of the ATM 300. The terminal surveillance device 100 can recognize a state of the inside of the ATM 300 by acquiring state information. The ATM 300 according to the present embodiment has one or more states that are classified in accordance with the type of processing executed in the ATM 300, the type of operation accepted from a user, and the like. The state transitions of the ATM 300 may be synchronized, for example, with the transitions of screens displayed on the operation display unit 315. The following describes examples of the states and state transitions of the ATM 300 with reference to FIG. 4.

FIG. 4 is a flowchart illustrating an example of the state transitions of the ATM 300, from which money is withdrawn. As illustrated in FIG. 4, the ATM 300 first enters a standby state (step S102), and stands by until the transaction button is operated (step S104/NO). Once the transaction button is operated (step S104/YES), the ATM 300 transitions to a card insertion waiting state (step S106) and stands by until a card is inserted (step S108/NO). Once a card is inserted into the card insertion slot 312 (step S108/YES), the ATM 300 transitions to a transition start processing state and performs a transition start processing such as reading card information from the inserted card (step S110). Next, the ATM 300 transitions to a personal identification number reception state (step S112), and stands by until the personal identification number is entered (step S114/NO). Once the personal identification number is entered (step S114/YES), the ATM 300 transitions to a transaction volume reception state (step S116) and stands by until a transaction volume is entered (step S118/NO). Once a transaction volume is entered (step S118/YES), the ATM 300 transitions to a withdrawal processing state and performs withdrawal processing such as communicating with and authenticating a financial institution server for dispensing the money corresponding to the entered transaction volume (step S120). The ATM 300 then transitions to a bill/coin ejection processing state to dispense a bill and a coin to the bill dispensing slot 314 and the coin dispensing slot 313 (step S122) and stands by until the bill and the coin are picked up (step S124/NO). Once the user picks up the bill and the coin (step S124/YES), the ATM 300 transitions to a medium ejection processing state to eject the card and the statement (step S126) and stands by until the card and the statement are picked up (step S128/NO). Afterwards, once the user picks up the card and the statement (step S128/YES), the ATM 300 transitions to the standby state again (step S102).

The above-described state transitions are merely examples. One or more of the above-described states may be skipped, or another state may be added.

The state information acquisition unit 130 acquires state information on the basis of a signal output from the ATM 300 in the present embodiment. The state information acquisition unit 130 according to the present embodiment is connected to the ATM 300 in a wired or wireless manner directly or indirectly via another device. The state information acquisition unit 130 may also receive a signal indicating state information via a wired communication or wireless communication interface provided to the ATM 300. This allows the state information acquisition unit 130 to acquire more accurate state information than that of a second embodiment described below.

### (4) Determination Unit 140

The determination unit 140 has a function of determining whether a specific motion extracted by the extraction unit 120 is a normal motion, on the basis of the relationship between the specific motion and state information acquired by the state information acquisition unit 130. As described above, the motion of attaching a skimmer into the card insertion slot 312 looks similar to the motion of normally putting a card into the card insertion slot 312. Therefore, the motion of attaching a skimmer can also be extracted as a specific motion. In contrast, the determination unit 140 can determine whether the specific motion is the normal motion (e.g., motion of normally putting a card into the card insertion slot 312) corresponding to the state information or an abnormal motion (e.g., motion of attaching a skimmer into the card insertion slot 312) not corresponding to the state information.

For example, the determination unit 140 may also determine whether the specific motion is a normal motion, on the basis of whether the specific motion is the motion corresponding to the state of the ATM 300. For example, when the specific motion of inserting a card is extracted in the card insertion waiting state (step S106 in FIG. 4), the determination unit 140 determines that the specific motion is a normal motion. Meanwhile, when the specific motion of inserting a card is extracted in a state other than the card insertion waiting state, the determination unit 140 determines that the specific motion is an abnormal motion. This allows the determination unit 140 to determine, for example, the motion of attaching a skimmer in a state other than the card insertion waiting state as an abnormal motion.

For example, the determination unit 140 may also determine whether the specific motion is a normal motion, on the basis of the presence or absence of the state transition corresponding to the specific motion at the ATM 300. For example, When the specific motion of inserting a card is extracted in the card insertion waiting state (step S106 in FIG. 4), and then ATM 300 transitions to the transaction start processing (step S110 in FIG. 4), the determination unit 140 determines that the specific motion is a normal motion. This is because it is considered that the actual insertion of the card causes the state to transition. Meanwhile, when the specific motion of inserting a card is extracted in the card insertion waiting state, and then the ATM 300 does not transition to the transaction start processing, the determination unit 140 determines that the specific motion is an abnormal motion. This is because it is considered that a motion such as attaching a skimmer is made in fact, no card is inserted, and therefore the state does not transition. This allows the determination unit 140 to determine, for example, the motion of attaching a skimmer in the card insertion waiting state as an abnormal motion.

The determination unit 140 outputs information indicating a determination result to the report unit 150. Additionally, a determination result from the determination unit 140 may have stages. For example, a determination result may be set to have multiple stages from the stage of a definitive abnormal motion to the stage of a tentative abnormal motion.

### (5) Report Unit 150

The report unit 150 has a function of reporting a determination result from the determination unit 140. For example, the report unit 150 reports a determination result to the manager who manages the ATM 300. This allows the manager to deactivate the ATM 300 at which an abnormal motion is detected or have a security guard inspect the ATM 300 at which an abnormal motion is detected. The report unit 150 may include a wired/wireless interface, and report a determination result to another terminal such as a terminal for the manager or a terminal for a security guard. Further, the report unit 150 may include a display unit and/or an audio output unit, and output a determination result to a user of the terminal surveillance device 100.

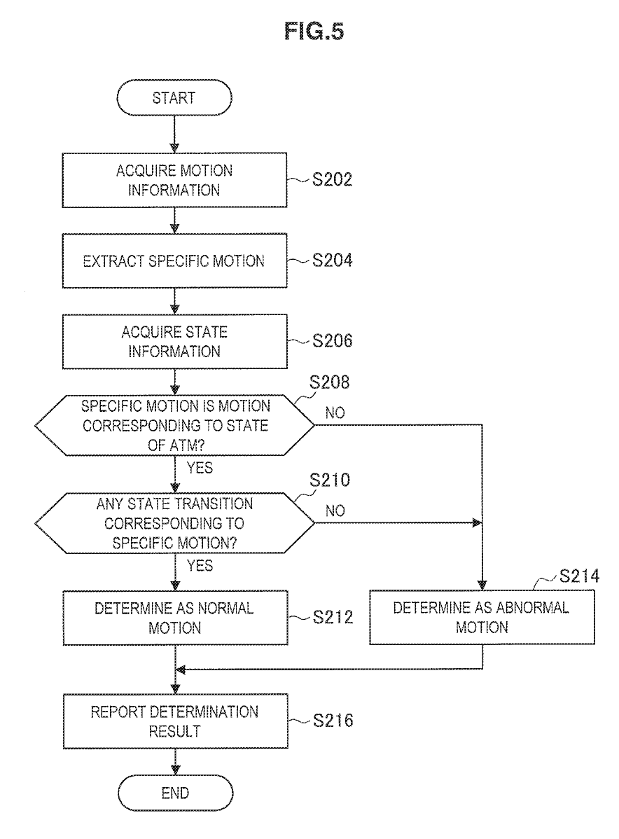

The configuration example of the terminal surveillance device 100 according to the present embodiment has been described above. Next, an operation processing example of the terminal surveillance device 100 according to the present embodiment will be described with reference to FIG. 5.

### 2.2. Operation Processing Example

FIG. 5 is a flowchart illustrating an example of the flow of the terminal surveillance processing executed by the terminal surveillance device 100 according to the present embodiment.

As illustrated in FIG. 5, the motion information acquisition unit 110 acquires motion information (step S202), and the extraction unit 120 extracts a specific motion of a user from the motion information acquired by the motion information acquisition unit 110 (step S204). Further, the state information acquisition unit 130 acquires the state information of the ATM 300 on the basis of a signal output from the ATM 300.

Next, the determination unit 140 determines whether the specific motion is the motion corresponding to the state of the ATM 300 (step S208). Further, the determination unit 140 determines whether the state transition of the ATM 300 corresponding to the specific motion is present (step S210).

If it is determined that the specific motion is the motion corresponding to the state of the ATM 300 (step S208/YES) and the state transition of the ATM 300 corresponding to the specific motion is present (step S210/YES), the determination unit 140 determines that the specific motion is a normal motion (step S212).

Meanwhile, if it is determined that the specific motion is not the motion corresponding to the state of the ATM 300 (step S208/NO) or the state transition of the ATM 300 corresponding to the specific motion is absent (step S210/NO), the determination unit 140 determines that the specific motion is an abnormal motion (step S214).

The report unit 150 then reports a determination result indicating whether the specific motion is a normal motion or an abnormal motion (step S216).

### 3. Second Embodiment

The terminal surveillance device 100 acquires information indicating the state of the ATM 300 on the basis of the appearance of the ATM 300 in the present embodiment.

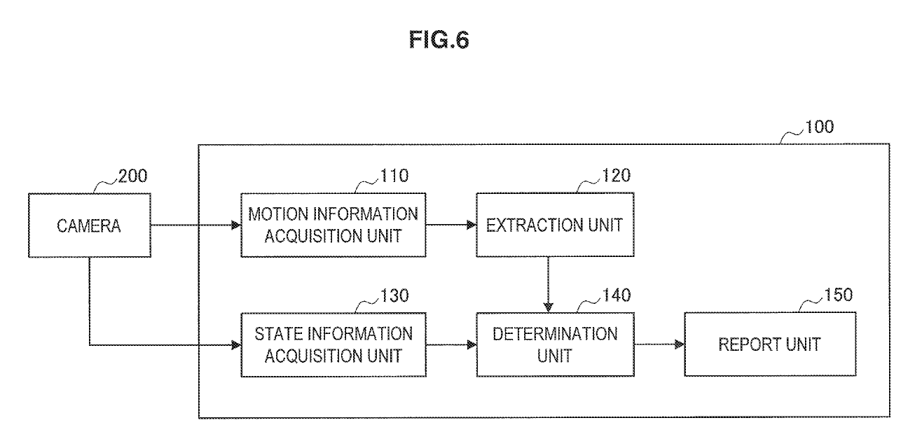

FIG. 6 is a block diagram illustrating an example of the logical configuration of the terminal surveillance device 100 according to the present embodiment. As illustrated in FIG. 6, the terminal surveillance device 100 is configured in the same way as the terminal surveillance device 100 according to the first embodiment illustrated in FIG. 3. The following describes the configuration characteristic of the terminal surveillance device 100 according to the present embodiment.

The state information acquisition unit 130 according to the present embodiment acquires state information on the basis of sensor information output from the sensor device that targets the ATM 300 for sensing. In the example illustrated in FIG. 6, the state information acquisition unit 130 acquires state information from a moving image of the ATM 300 shot by the camera 200. For example, the state information acquisition unit 130 may also estimate state information from a screen transition of the operation display unit 315. Additionally, a sensor device for the motion information acquisition unit 110 may be the same as or different from a sensor device for the state information acquisition unit 130. The ATM 300 does not have to be provided with any interface for outputting a signal indicating state information to allow the terminal surveillance device 100 to detect an abnormal motion in the present embodiment. It is therefore possible in the present embodiment to make the ATM 300 more independent and secure than in the first embodiment.

For example, the state information acquisition unit 130 may acquire state information on the basis of sensor information obtained by sensing information reported from a report device provided to the ATM 300. This allows the terminal surveillance device 100 to acquire more accurate state information and detect an abnormal motion even if the ATM 300 outputs no signal indicating the state. The state information acquisition unit 130 can acquire state information, for example, from a shot image showing the state displayed on the display device or a sound from the audio output device indicating the state.

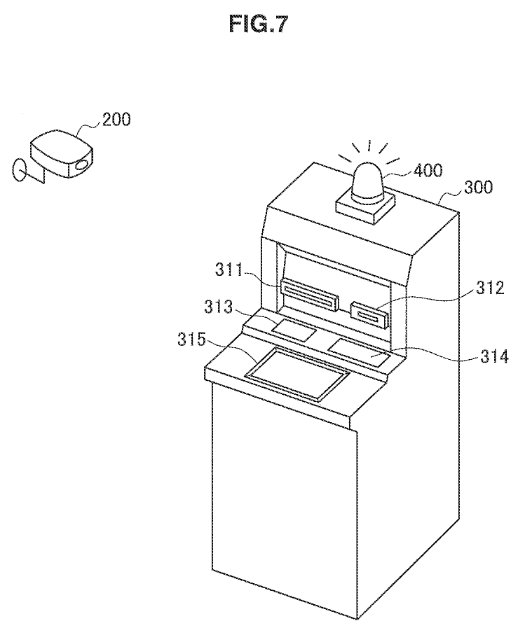

The report device may be replaced with an existing device included in the ATM 300. For example, the report device may be implemented by a lamp provided around the operation display unit 315 or the card insertion slot 312. Further, the report device may be newly provided to the ATM 300. The following describes an example of the report device newly provided to the ATM 300 with reference to FIG. 7.

FIG. 7 is a diagram for describing an example of a report device provided to the ATM 300 according to the present embodiment. As illustrated in FIG. 7, the ATM 300 is provided a report device 400. In the example illustrated in FIG. 7, the report device 400 is a lamp (display device). For example, the lamp 400 blinks in different patterns in accordance with the states of the ATM 300. The lamp 400 can report the states of the ATM 300, for example, by colors, blinking patterns, or blinking speed. In the example illustrated in FIG. 7, the lamp 400 is provided at a higher position than that of the card insertion slot 312 of the ATM 300. In this case, the camera 200 can more easily shoot an image of the lamp 400 than when the camera 200 shoots an image of a lamp provided around the card insertion slot 312. Additionally, there may be multiple report devices 400 or the report device 400 may be provided separately from the ATM 300.

Additionally, when the report device 400 is a display device as illustrated in FIG. 7, the state information acquisition unit 130 performs image analysis on an image sequence shot by the camera 200 and obtains the background differences to acquire state information.

The configuration example of the terminal surveillance device 100 according to the present embodiment has been described above. The operation processing example is similar to that of the first embodiment described above with reference to FIG. 5, and will not therefore described here in detail.

### 4. Hardware Configuration Example

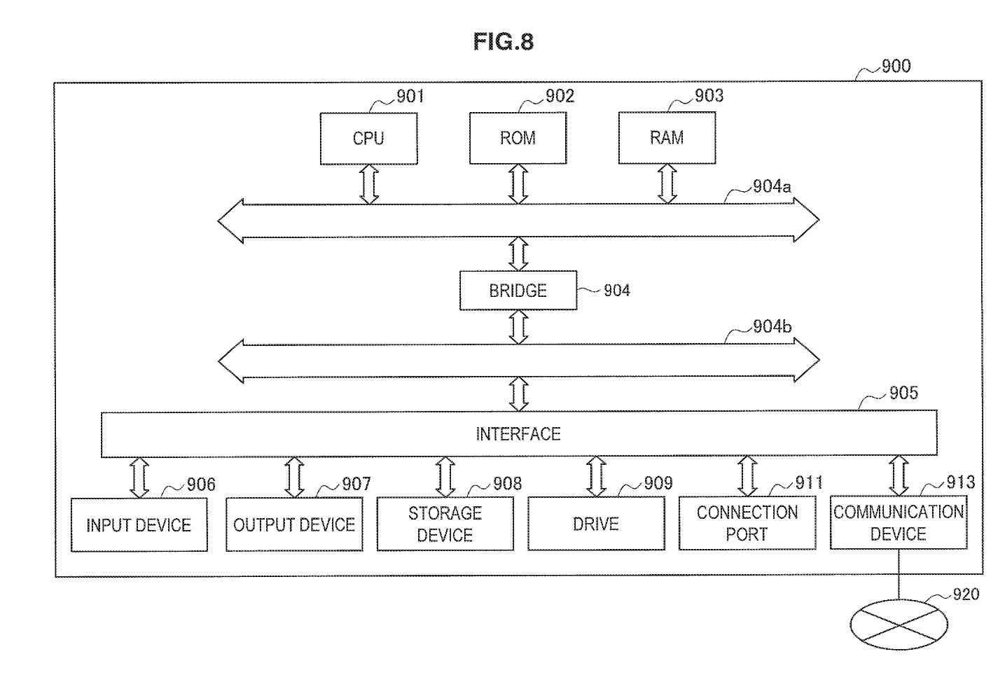

Finally, a hardware configuration example of an information processing device according to the present embodiment will be described with reference to FIG. 8. FIG. 8 is a block diagram illustrating an example of the hardware configuration of the information processing device according to the present embodiment.

Additionally, an information processing device 900 illustrated in FIG. 8 can implement the terminal surveillance device 100, for example, illustrated in FIGS. 3 and 6. Information processing executed by the terminal surveillance device 100 according to the present embodiment is executed in coordination with software and hardware described below.

As illustrated in FIG. 8, the information processing device 900 includes a central processing unit (CPU) 901, a read only memory (ROM) 902, a random access memory (RAM) 903, and a host bus 904a. Further, the information processing device 900 includes a bridge 904, an external bus 904b, an interface 905, an input device 906, an output device 907, a storage device 908, a drive 909, a connection port 911, and a communication device 913. The information processing device 900 may include a processing circuit such as a DSP or an ASIC instead of or in combination with the CPU 901.

The CPU 901 functions as a processing device and a control device, and controls the overall operation of the information processing device 900 in accordance with a variety of programs. The CPU 901 may also be a microprocessor. The ROM 902 stores a program, an operation parameter, or the like that is used by the CPU 901. The RAM 903 temporarily stores a program used upon execution of the CPU 901, a parameter that changes as necessary for the execution, or the like. The CPU 901 can be included in the extraction unit 120, the state information acquisition unit 130, and the determination unit 140, for example, illustrated in FIGS. 3 and 6.

The CPU 901, the ROM 902, and the RAM 903 are connected to each other by the host bus 904a including a CPU bus. The host bus 904a is connected to the external bus 904b such as a peripheral component interconnect/interface (PCI) bus via the bridge 904. Additionally, the host bus 904a, the bridge 904, and the external bus 904b do not have to be necessarily separate, but the functions thereof may also be implemented in a single bus.

The input device 906 is implemented, for example, by a mouse, a keyboard, a touch panel, a button, a microphone, a switch, and a lever with which a user inputs information. In addition, the input device 906 may be, for example, a remote control device using infrared light or other radio waves, or may be an external connection device 929 such as a mobile phone and a PDA operable in response to the operation of the information processing device 900. Further, the input device 906 may include, for example, an input control circuit or the like that generates an input signal on the basis of information input by a user using the above-described input means, and outputs the input signal to the CPU 901. A user of the information processing device 900 can input a variety of data to the information processing device 900 and request the information processing device 900 to perform a processing operation by operating this input device 906.

The output device 907 includes a device capable of visually or aurally reporting acquired information to the user. Such a device includes a display device such as a CRT display device, a liquid crystal display device, a plasma display device, an EL display device and a lamp, an audio output device such as a speaker and a headphone, a printer device, or the like. The output device 907 outputs, for example, results obtained from various types of processing performed by the information processing device 900. Specifically, the display device visually displays results obtained from various types of processing performed by the information processing device 900 in a variety of forms such as text, an image, a table, and a graph. Meanwhile, the audio output device converts audio signals including reproduced audio data, acoustic data, or the like into analog signals, and aurally outputs the analog signals. The above-described display device and audio output device can be included in the report unit 150, for example, illustrated in FIGS. 3 and 6.

The storage device 908 is a device for data storage which is configured as an example of a storage unit of the information processing device 900. The storage device 908 is implemented, for example, as a magnetic storage device such as a HDD, a semiconductor storage device, an optical storage device, a magneto-optical storage device, or the like. The storage device 908 may include a storage medium, a recording device that records data on a storage medium, a read-out device that reads data out from a storage medium, and a deletion device that deletes data recorded on a storage medium. The storage device 908 stores a program to be executed by the CPU 901, various types of data, various types of data acquired from the outside, and the like.

The drive 909 is a reader/writer for a storage medium, and is built in or externally attached to the information processing device 900. The drive 909 reads out information recorded on a removable storage medium such as a mounted magnetic disk, an optical disc, a magneto-optical disk, and semiconductor memory, and outputs the read-out information to the RAM 903. The drive 909 can also write information into a removable storage medium.

The connection port 911 is an interface connected to an external device, and is a connection port for an external device capable of transmitting data, for example, via a universal serial bus (USB).

The communication device 913 is, for example, a communication interface including a communication device and the like for a connection to a network 920. Examples of the communication device 913 include a communication card for a wired or wireless local area network (LAN), Long Term Evolution (LTE), Bluetooth (registered trademark) or a wireless USB (WUSB). In addition, the communication device 913 may be a router for optical communication, a router for an asymmetric digital subscriber line (ADSL), a modem for various kinds of communication, or the like. This communication device 913 can transmit and receive signals or the like, for example, to and from the Internet or other communication devices in compliance with a predetermined protocol such as TCP/IP. The communication device 913 can be included in the motion information acquisition unit 110, the state information acquisition unit 130, and the report unit 150, for example, illustrated in FIGS. 3 and 6.

Additionally, the network 920 is a wired or wireless transmission path through which information is transmitted from an apparatus connected to the network 920. The network 920 may include public networks such as the Internet, telephone networks and satellite networks, a variety of local area networks (LANs) including Ethernet (registered trademark), and wide area networks (WANs). The network 920 may also include leased line networks such as Internet protocol-virtual private networks (IP-VPNs).

The example of the hardware configuration that can implement the functions of the information processing device 900 according to the present embodiment has been described above. Each of the above-described components may be implemented by a general-purpose member, and may also be implemented by hardware specialized in the function of each component. The hardware configuration used can thus be modified as appropriate in accordance with the technological level at the time of the implementation of the present embodiment.

It is possible to create a computer program for implementing each function of the information processing device 900 according to the above-described embodiment, and to implement the computer program in a PC or the like. Further, there can also be provided a computer-readable recording medium (i.e., storage medium) having such a computer program stored therein. Examples of the recording medium include a magnetic disk, an optical disc, a magneto-optical disk, and a flash memory. The computer program may also be distributed via a network, for example, using no recording medium.

### 5. Conclusion

The embodiment of the present invention has been described above in detail with reference to FIGS. 1 to 8. As described above, the terminal surveillance device 100 extracts a specific motion of a user from motion information indicating a motion of a user at the ATM 300, and determines whether the extracted specific motion is a normal motion, on the basis of the relationship between the specific motion and the state information of the ATM 300. This allows the terminal surveillance device 100 to accurately detect an abnormal motion without mistaking the abnormal motion for a normal motion even if a skimmer miniaturized in recent years would be attached by a motion similar to a normal motion.

The preferred embodiment(s) of the present invention has/have been described above with reference to the accompanying drawings, whilst the present invention is not limited to the above examples. A person skilled in the art may find various alterations and modifications within the scope of the appended claims, and it should be understood that they will naturally come under the technical scope of the present invention.

For example, the terminal surveillance device 100 is separated from the camera 200 in the above-described embodiments, but the present invention is not limited to the examples. For example, the terminal surveillance device 100 may be integrated with the camera 200.

Further, attaching a skimmer to the card insertion slot 312 is targeted for surveillance in the above-described embodiments, but the present invention is not limited to the examples. For example, the terminal surveillance device 100 may target for surveillance attaching a skimmer to the passbook insertion slot 311, attaching a skimmer to a processing terminal for credit cards, and attaching a device for secretly shooting images of fingerprints of a user and operations of entering personal identification numbers. In addition, a sheet device that is installed on the top of the operation display unit 315 and acquires the details of a touch operation of a user while transmitting the operation to the operation display unit 315 may be targeted for surveillance.

The processing described herein with reference to the flowcharts and the sequence diagrams does not necessarily have to be executed in the illustrated order.

Some processing steps may be executed in parallel. Additional processing steps may also be adopted, while some of the processing steps may be omitted.

### REFERENCE SIGNS LIST

terminal surveillance system
100 terminal surveillance device
110 motion information acquisition unit
120 extraction unit
130 state information acquisition unit
140 determination unit
150 report unit
200 camera
300 ATM
311 passbook insertion slot
312 card insertion slot
313 coin dispensing slot
314 bill dispensing slot
315 operation display unit
400 report device

1. A terminal surveillance device comprising:
a motion information acquisition unit configured to acquire motion information indicating a motion of a user at a terminal device;
a specification unit configured to specify a specific motion of the user from the motion information acquired by the motion information acquisition unit;
a state information acquisition unit configured to acquire state information indicating a state of the terminal device; and
a decision unit configured to decide whether the specific motion specified by the specification unit is a normal motion, on the basis of a relationship between the specific motion and the state information acquired by the state information acquisition unit.

2. The terminal surveillance device according to claim 1, wherein
the decision unit decides whether the specific motion is a normal motion, on the basis of whether the specific motion is a motion corresponding to the state of the terminal device.

3. The terminal surveillance device according to claim 1, wherein
the decision unit decides whether the specific motion is a normal motion, on the basis of whether the terminal device transitions to a state corresponding to the specific motion after the specific motion is specified.

4. The terminal surveillance device according to claim 1, further comprising:
a report unit configured to report a decision result from the decision unit.

5. The terminal surveillance device according to claim 1, wherein
the state information acquisition unit acquires the state information on the basis of a signal output from the terminal device.

6. The terminal surveillance device according to claim 1, wherein
the state information acquisition unit acquires the state information on the basis of sensor information output from a sensor device that targets the terminal device for sensing.

7. The terminal surveillance device according to claim 6, wherein
the state information acquisition unit acquires the state information on the basis of the sensor information obtained by sensing information reported from a report device provided to the terminal device.

8. The terminal surveillance device according to claim 7, wherein
the report device is provided at a higher position than a position of a card insertion slot of the terminal device.

9. The terminal surveillance device according to claim 1, wherein
the motion information acquisition unit acquires the motion information from a camera that acquires a moving image or a still image.

10. The terminal surveillance device according to claim 1, wherein
the terminal device is an automatic teller machine.

11. The terminal surveillance device according to claim 1, wherein
the decision unit decides whether the specific motion is a normal motion, on the basis of whether the specific motion is specified after a transition of the state of the terminal device, and a state to which the terminal device transitions is a state corresponding to the specified specific motion.

12. (canceled)

13. A terminal surveillance device comprising:
a memory and/or a storage device configured to store data; and
a control unit, wherein
the memory and/or the storage device stores each of 1) a motion information acquisition module, 2) a specification module, 3) a state information acquisition module, and 4) a decision module,
the control unit executes each of the modules in 1) to 4), and a detail of execution of the control unit includes following A) to D):
A) executing the motion information acquisition module to acquire motion information indicating a motion of a user at a terminal device;
B) executing the specification module to specify a specific motion of the user on the basis of the motion information acquired in A);
C) executing the state information acquisition module to acquire state information indicating a state of the terminal device; and
D) executing the decision module to decide whether the specific motion specified in B) is a normal motion, on the basis of a relationship between the specific motion and the state information acquired in C).

14. An automatic teller machine comprising:
a motion information acquisition unit configured to acquire motion information indicating a motion of a user;
a specification unit configured to specify a specific motion of the user from the motion information acquired by the motion information acquisition unit;
a state information acquisition unit configured to acquire state information indicating a state of the automatic teller machine; and
a decision unit configured to decide whether the specific motion specified by the specification unit is a normal motion, on the basis of a relationship between the specific motion and the state information acquired by the state information acquisition unit.

15. The automatic teller machine according to claim 14, wherein
the state information acquisition unit acquires the state information on the basis of sensor information output from a sensor included in the automatic teller machine.

16. The automatic teller machine according to claim 14, further comprising:
a report unit configured to report a decision result from the decision unit;
a sensor configured to output sensor information as a sensing result; and
a camera configured to output an image, wherein
the state information acquisition unit acquires the state information on the basis of at least two of the sensor information, the image, and the decision result.

17. The automatic teller machine according to claim 14, further comprising:
a sensor configured to output sensor information as a sensing result;
a lamp; and
a camera configured to output an image, wherein
the state information acquisition unit acquires the state information on the basis of at least one of an image obtained by the camera capturing display of the lamp, and the sensor information.

18. An automatic teller machine comprising:
a memory and/or a storage device configured to store data; and
a control unit, wherein
the memory and/or the storage device stores each of 1) a motion information acquisition module, 2) a specification module, 3) a state information acquisition module, and 4) a decision module,
the control unit executes each of the modules in 1) to 4), and a detail of execution by the control unit includes following A) to D):
A) executing the motion information acquisition module to acquire motion information indicating a motion of a user;
B) executing the specification module to specify a specific motion of the user on the basis of the motion information acquired in A);
C) executing the state information acquisition module to acquire state information indicating a state of the automatic teller machine; and
D) executing the decision module to decide whether the specific motion specified in B) is a normal motion, on the basis of a relationship between the specific motion and the state information acquired in C).

19. A decision method comprising:
a first step of acquiring motion information indicating a motion of a user;
a second step of specifying a specific motion of the user on the basis of the motion information;
a third step of acquiring state information indicating a state of a terminal device; and
a fourth step of deciding whether the specific motion is a normal motion, on the basis of a relationship between the specific motion and the state information, wherein
a control unit executes the first to fourth steps, and it is decided as a result whether the motion of the user is normal.

20. A recording medium on which is stored a program causing a computer to function as:
a motion information acquisition unit configured to acquire motion information indicating a motion of a user;
a specification unit configured to specify a specific motion of the user on the basis of the motion information acquired by the motion information acquisition unit;
a state information acquisition unit configured to acquire state information indicating a state of a terminal device; and
a decision unit configured to decide whether the specific motion is a normal motion, on the basis of a relationship between the specific motion and the state information.
